(19) United States
(12) Patent Application Publication
(10) Pub. No.: US 2026/0337783 A1
(43) Pub. Date: Oct. 29, 2026

(54) Nickel-Niobium Intermetallic Cladding on Metal Substrate

(71) Applicant: L.E. Jones Company, Menominee, MI (US)

(72) Inventors: Cong Yue Qiao, Menominee, MI (US); David M. Doll, Fort Worth, TX (US); Joseph E. Schreiner, Marinette, WI (US)

(73) Assignee: L.E. Jones Company, Menominee, MI (US)

(21) Appl. No.: 19/192,972

(22) Filed: Apr. 29, 2025

(51) Int. Cl. C23C 24/10; B23K 26/342; B23K 103/04; B23K 103/08; B23K 103/18; B32B 15/01; C22C 19/05; C22C 30/02; C22C 30/04; C22C 38/02; C22C 38/04; C22C 38/42; C22C 38/44; C22C 38/46; C22C 38/48; C22C 38/52; C22C 38/54

(52) U.S. Cl. CPC C23C 24/106; B23K 26/342; B32B 15/015; C22C 19/055; C22C 30/02; C22C 30/04; C22C 38/02; C22C 38/04; C22C 38/42; C22C 38/44; C22C 38/46; C22C 38/48; C22C 38/52; C22C 38/54; B23K 2103/04; B23K 2103/08; B23K 2103/26; B32B 2311/22

(57) ABSTRACT

An article comprises a metal substrate and a nickel-niobium intermetallic alloy cladding thereon. The nickel-niobium intermetallic alloy cladding is bonded to the metal substrate by a fusion boundary and the nickel-niobium intermetallic alloy cladding is made from pre-alloyed nickel-niobium intermetallic alloy powder having up to 0.1 weight percent (wt. %) carbon. The nickel-niobium intermetallic alloy cladding has an as-clad microstructure comprising at least 80 volume % nickel-niobium intermetallic phases and up to 20 volume % solid solution phases.

### BACKGROUND

With common cladding processes such as laser beam welding, plasma transferred arc welding, GTA, and GMA, γ′ and/or γ″ dissolves into nickel matrix phase clad material. Reduction of aluminum and titanium content can take place due to some of aluminum and titanium elements being removed into welding surface oxide. Gamma prime and gamma double prime phases can be reinstated in clad material through precipitation heat treatment; however, for many clad equipment or structures the post clad heat treatment cannot be performed without involving substantial high process cost. There is a need for lower cost cladding materials having wear and corrosion resistance such as a nickel-niobium intermetallic alloy cladding as disclosed herein.

### SUMMARY

An article comprising a metal substrate and a nickel-niobium intermetallic alloy cladding thereon, the nickel-niobium intermetallic alloy cladding bonded to the metal substrate by a fusion boundary, the nickel-niobium intermetallic alloy cladding made from pre-alloyed nickel-niobium intermetallic alloy powder having up to 0.1 weight percent (wt. %) carbon, and the nickel-niobium intermetallic alloy cladding having a microstructure comprising at least 80 volume % nickel-niobium intermetallic phases and up to 20 volume % solid solution phases.

In an embodiment, the nickel-niobium intermetallic alloy cladding consists of, in weight percent, up to 3.5 percent silicon; 5 to 15 percent chromium; 45 to 75 percent nickel; 14 to 30 percent niobium; up to 7 percent cobalt; up to 10 percent iron; up to 0.1 percent carbon, up to 0.2 percent manganese, up to 0.5 percent molybdenum, up to 0.3 percent tungsten, up to 0.3 percent vanadium, and up to 0.1 percent each of titanium, zirconium, hafnium, tantalum, beryllium, aluminum, boron, sulfur, phosphorus, copper, calcium, nitrogen, oxygen, selenium, lead, yttrium, rare earth metals, and bismuth.

In an embodiment, the metal substrate is a nickel-base alloy and/or the nickel-niobium intermetallic alloy cladding comprises at least 90 volume % nickel-niobium intermetallic alloy phases.

In an embodiment, the cladding has been deposited by laser cladding and/or the article is a valve seat insert.

In an embodiment, the metal substrate comprises a wear resistant tool steel or a low alloy steel. For example, the metal substrate can comprise a wear resistant tool steel comprising 1 to 2 percent carbon, 7 to 15 percent chromium, 4 to 12 percent molybdenum, up to 5 percent tungsten, up to 4 percent cobalt, up to 4 percent niobium, up to 3 percent vanadium, up to 4percent copper, up to 2 percent manganese, up to 2 percent silicon, up to 1 percent nickel, up to 1 percent boron, 60 to 80 percent iron and balance up to 1 percent unavoidable impurities. Or the metal substrate can comprise a low alloy steel comprising 0.3 to 0.5 percent carbon, 0.5 to 1.5percent chromium, 0.15 to 0.5 percent molybdenum, up to 0.5 percent tungsten, up to 0.5 percent cobalt, up to 0.5 percent niobium, up to 0.5 percent vanadium, up to 0.5 percent copper, 0.5 to 1.5 percent manganese, 0.15 to 0.5 percent silicon, up to 0.5 percent nickel, up to 0.1 percent boron, up to 1 percent unavoidable impurities, balance iron.

In an embodiment, the nickel-niobium intermetallic alloy cladding has a uniform hardness of between 500 and 600 HV across an outer surface and in a depth direction of at least 1 mm from the outer surface and/or the cladding has a hardness of 50-55 HRc after being heated at 775 °C for 250 hours.

In an embodiment, the nickel-niobium intermetallic alloy cladding has an outer zone of uniform lamellar microstructure and an inner zone of dendritic nickel-niobium intermetallic alloy extending outwardly from an outer surface of the metal substrate.

In an embodiment, an article comprises a metal substrate and a nickel-niobium intermetallic alloy cladding thereon, wherein the nickel-niobium intermetallic alloy cladding is bonded to the metal substrate by a fusion boundary, the nickel-niobium intermetallic alloy cladding made from pre-alloyed nickel-niobium intermetallic alloy powder, the nickel-niobium intermetallic alloy cladding having a microstructure comprising at least 80 volume % nickel-niobium intermetallic phases and up to 20 volume % solid solution phases, the nickel-niobium intermetallic alloy cladding consisting of, in weight percent, up to 3.5 percent silicon; 5 to 15 percent chromium; 45 to 75 percent nickel; 14 to 30 percent niobium; up to 7 percent cobalt; up to 10 percent iron; up to 0.1 percent carbon, up to 0.2 percent manganese, up to 0.5 percent molybdenum, up to 0.3 percent tungsten, up to 0.3 percent vanadium, and up to 0.1 percent each of titanium, zirconium, hafnium, tantalum, beryllium, aluminum, boron, sulfur, phosphorus, copper, calcium, nitrogen, oxygen, selenium, lead, yttrium, rare earth metals, and bismuth, and the metal substrate is a tool steel comprising 1 to 2 percent carbon, 7 to 15 percent chromium, 6 to 12 percent molybdenum, up to 5 percent tungsten, up to 5 percent cobalt, up to 4 percent niobium, up to 3 percent vanadium, up to 4 percent copper, up to 2 percent manganese, up to 2 percent silicon, up to 3 percent nickel, up to 0.5 percent boron, up to 1 percent unavoidable impurities, balance iron.

In an embodiment, the nickel-niobium intermetallic alloy cladding is formed by feeding a pre-alloyed powder of the nickel niobium intermetallic alloy to a nozzle of a laser cladding apparatus which deposits the nickel-niobium intermetallic alloy cladding on the metal substrate. For example, the laser cladding can be performed using a laser power of 250 to 10,000 watts, a powder feed rate of 1 to 40 grams per minute, a scanning speed of 5 to 50 millimeters per second, a laser spot diameter of 1.5 to 6 mm, an overlapping rate of 25 to 60%, a protective gas flow of 10 to 30 liters per minute, a powder size of 100 to 600 mesh (20-150 microns), and/or a single pass cladding thickness of 0.1 to 5 mm.

In an embodiment, the pre-alloyed powder is an atomized powder containing, in weight percent, up to 3.5 percent silicon; 5 to 15 percent chromium; 45 to 75 percent nickel; 14 to 30percent niobium; up to 7 percent cobalt; up to 10 percent iron, up to 0.1 percent carbon, up to 0.2percent manganese, up to 0.5 percent molybdenum, up to 0.3 percent tungsten, up to 0.3 percent vanadium, and up to 0.1 percent each of titanium, zirconium, hafnium, tantalum, beryllium, aluminum, boron, sulfur, phosphorus, copper, calcium, nitrogen, oxygen, selenium, lead, yttrium, rare earth metals, and bismuth.

In an embodiment, the nickel-niobium intermetallic alloy cladding has no more than 2.5 volume percent carbide/nitride phase including niobium carbides, niobium-molybdenum carbides, niobium nitrides and niobium carbonitrides.

In an embodiment, the nickel-niobium intermetallic alloy cladding includes rod-like intermetallic phases of nickel-niobium.

In an embodiment, the nickel-niobium intermetallic alloy cladding includes a lamellar microstructure.

In an embodiment, the nickel-niobium intermetallic alloy cladding has less than 10 volume percent nickel-iron and nickel-cobalt solid solution phases.

In an embodiment, the pre-alloyed powder is prepared by forming a melt of the pre-alloyed alloy and atomizing the melt to form the pre-alloyed powder.

In an embodiment, during the laser cladding an outer surface of the metal substrate is heated to melt the metal substrate into a weld pool, the pre-alloyed powder is melted and solidified into a microstructure of at least 90 volume percent intermetallic phases with a uniform microstructure as the nickel-niobium intermetallic alloy cladding is formed.

In an embodiment, the nickel-niobium intermetallic alloy cladding is deposited with a uniform microstructure of nickel-niobium intermetallic alloy phases metallurgically bonded to the metal substrate by a thin fusion boundary interface of mixed metal substrate and the thin fusion boundary interface having a thickness of no greater than 5 microns.

### BRIEF DESCRIPTION OF THE FIGURES

FIG. 1 is a graph of micro hardness traverses across laser claddings of a cobalt-based alloy (HB400) with up to 0.08% C, 7.5-9.9% Cr, up to 1.5% Fe, 27-30% Mo, up to 1.5% Ni, 2.2-3% Si, 56-58% Co and incidental impurities on a wear resistant iron-base alloy with 1.35% C, 10% Cr, 9% Mo, 1.5% Nb, 1.25% V, 0.2% B, 0.6% Si, 0.35% Mn, 1% Ni, 74-75% Fe and incidental impurities, an iron-based martensitic alloy (J513) with 1.9-2.1% C, 0.5% Si, 0.3-0.35% Mn, 15.5% Cr, 11.5-12% Mo, 1.5% W, 0.035-0.05% B, up to 2.1% Ni, 19-19.5% Co, 45-46.5% Fe and incidental impurities on the same metal substrate and a nickel-niobium intermetallic alloy (Jonesite 19) with 2.51% Si, 11.04% Cr, 25% Nb, 3.52% Co, 3.54% Fe, 54-55% Ni and incidental impurities on the same metal substrate.

FIG. 2 is a back-scattered electron image of a fusion zone for a nickel-niobium intermetallic alloy clad on a metal substrate.

FIGS. 3-5 show EDS analysis for spots in FIG. 2 where FIG. 3 is an EDS analysis results of spectrum spot 4 in FIG. 2; FIG. 4 is an EDS analysis results of spectrum spot 1 in FIG. 2; and FIG. 5 is an EDS analysis results of spectrum spot 5 in FIG. 2.

FIG. 6A is a back-scattered electron image and FIG. 6B shows elemental mapping of nickel, niobium, and molybdenum which confirms the matrix of nickel niobium intermetallic phases in a fusion zone of a nickel-niobium intermetallic alloy cladding on a metal substrate.

FIG. 7 is a micrograph at 50× of laser cladding of a nickel-niobium intermetallic alloy on a wear resistant tool steel.

FIG. 8A is a micrograph at 100× of a nickel-niobium intermetallic alloy clad on a metal substrate and FIG. 8B is a micrograph at 200× of the microstructure shown in FIG. 8A.

FIG. 9 is a graph of hardness versus time for a nickel-niobium intermetallic alloy cladding wherein it can be seen that the hardness remains essentially constant at between 50 and 55 HRc after heating at 775 °C for up to 250 hours.

FIG. 10 is a micrograph of a nickel-niobium intermetallic alloy cladding on a steel substrate wherein the fusion zone includes an inner 0.1-0.5 mm thick subzone of mixed substrate material and nickel-niobium intermetallic alloy underlies a 0.5-5 mm thick outer subzone of the nickel-niobium intermetallic alloy cladding.

### DETAILED DESCRIPTION

In comparison to conventional nickel-based superalloys, the material strength of Jonesite 19 (a nickel-niobium intermetallic alloy described in commonly-assigned U.S. Pat. No. 11,525,172, the subject matter of which is hereby incorporated by reference) alloy system is related to an intermetallic matrix. Disclosed herein is an article comprising a metal substrate such as low alloy and wear resistant tool steels, nickel-base alloy or other metal material having a nickel-niobium (Ni—Nb) intermetallic alloy cladding thereon. The cladding can be applied to the metal substrate by any suitable process such as an arc welding processes, energy beam processes, and other deposition processes suitable for establishing the intended cladding applications.

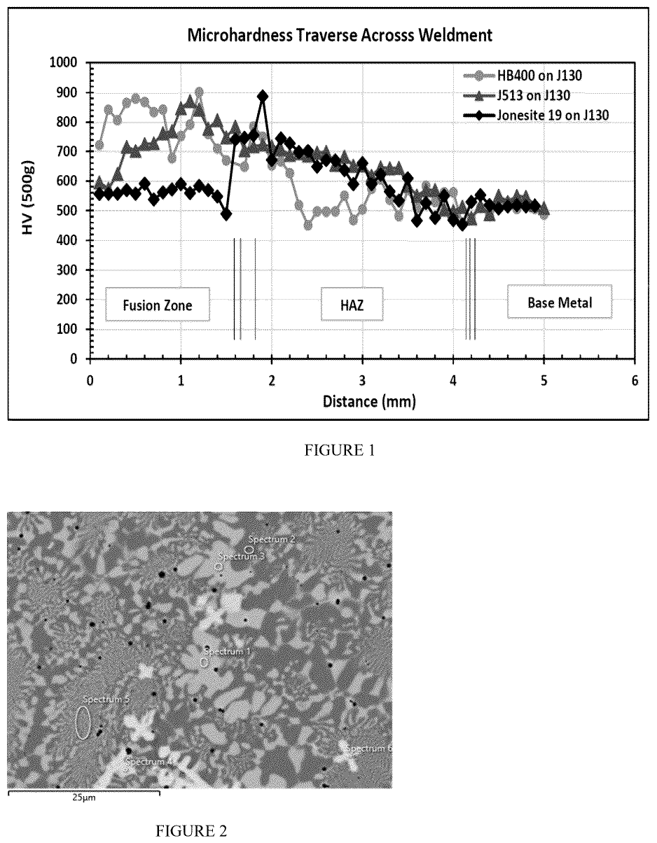

In an embodiment, a pre-alloyed nickel-niobium intermetallic alloy powder such as Jonesite 19 powder is laser clad on a metal substrate such as a heat-resistant steel, e.g., J130 (a heat and wear resistant tool steel described in commonly-assigned U.S. Pat. No. 6,702,905, the subject matter of which is hereby incorporated by reference) with 1 KW laser beam process. Under the welding energy input, bonding between the clad material and substrate material can be successfully made with or without applying blank preheat treatment. To compare the nickel-niobium intermetallic alloy cladding to other cladding materials applied to the same J130 substrate material, microhardness tests illustrated in the graph of FIG. 1 show variation in microhardness from the outer surface of the cladding to the substrate material of laser clad Jonesite 19 on a J130 substrate, laser clad J513 (an iron-based alloy described in commonly-assigned U.S. Pat. No. 9,932,867) on a J130 substrate, and laser clad HB400 on a J130 substrate. Compared to HB400 clad on J130 and J513 clad on J130, Jonesite 19 clad on J130 has displayed a significantly more uniform fusion zone microstructural distribution under the identical laser beam energy input which results in a more uniform metallurgical and mechanical property distribution. The microhardness traverse of the clad materials displayed in FIG. 1 show the very uniform microhardness distribution in the fusion zone of the Jonesite 19 cladding on J130.

As shown by hardness traverse Jonesite 19-J130 in FIG. 1, the microhardness of the fusion zone of Jonesite 19 on J130 was between 500-600 HV from the outer surface of the laser cladding to a depth of about 1.5 mm. In contrast as shown by hardness traverse HB400-J130, the microhardness of the fusion zone of a laser cladding of HB 400 on J130 varied from about 700 HV at the outer surface to about 900 HV at a depth of about 0.5 mm, dropped to below 700 HV at a depth of about 1 mm, rose to about 900 HV at a depth of about 1.2 mm and then dropped to about 650 HV at a depth of 1.5 mm. In another comparison shown by hardness traverse J513-J130, the microhardness of the fusion zone of a laser cladding of J513 on J130 varied from about 600 HV at the outer surface to about 900 HV at a depth of about 1.2 mm, then dropped to about 700 HV at a depth of 1.5 mm.

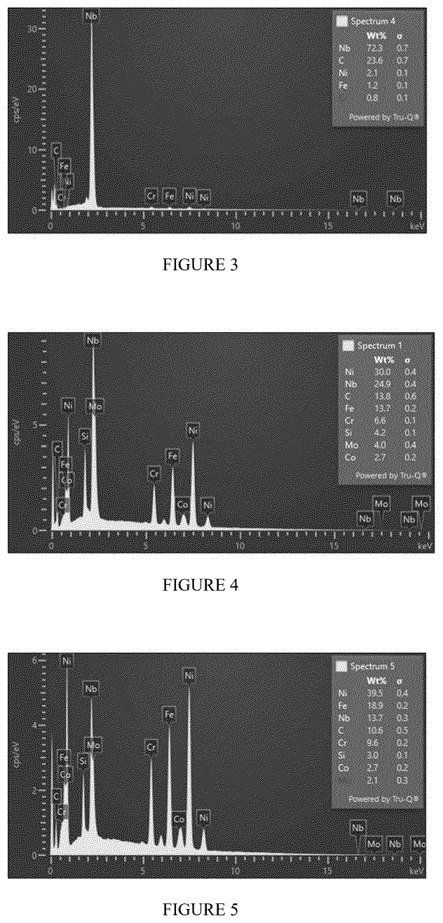

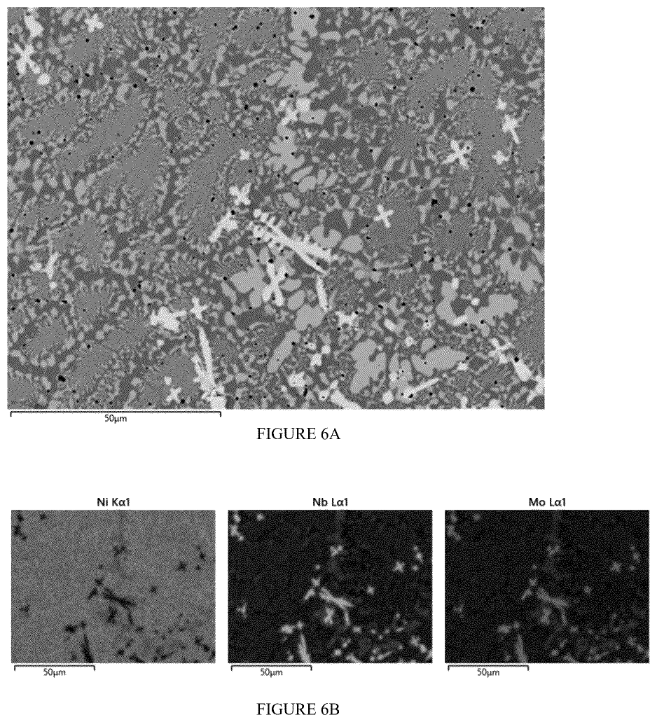

FIG. 2 shows fusion zone microstructural morphology of a Jonesite 19 cladding on a J130 substrate material. Besides the signature eutectic microstructures of alloy Jonesite 19, a small amount of carbides/nitrides such as niobium carbides, niobium-molybdenum carbides, niobium nitrides and niobium carbonitrides (less than 2.5 volume %) were also revealed as illustrated by EDS confirmation result shown in FIG. 3. The eutectic phases are composed of nickel-niobium intermetallic phases as manifested by EDS analysis results shown in FIGS. 4 and 5. FIG. 6A displays a back-scattered electron image and FIG. 6B shows elemental mapping of nickel, niobium, and molybdenum which confirms the matrix of nickel niobium intermetallic phases in a fusion zone of Jonesite 19 clad on J130. The molybdenum in the cladding originated from the J130 substrate material. Because the Jonesite 19 nickel-niobium intermetallic powder can include elements such as Si, Cr, Co and Fe, such elements can be in solid solution and/or combined in the nickel-niobium intermetallic phases of the nickel-niobium intermetallic cladding. Likewise, elements from the metal substrate can also be in solid solution and/or combined in the nickel-niobium intermetallic phases of the cladding.

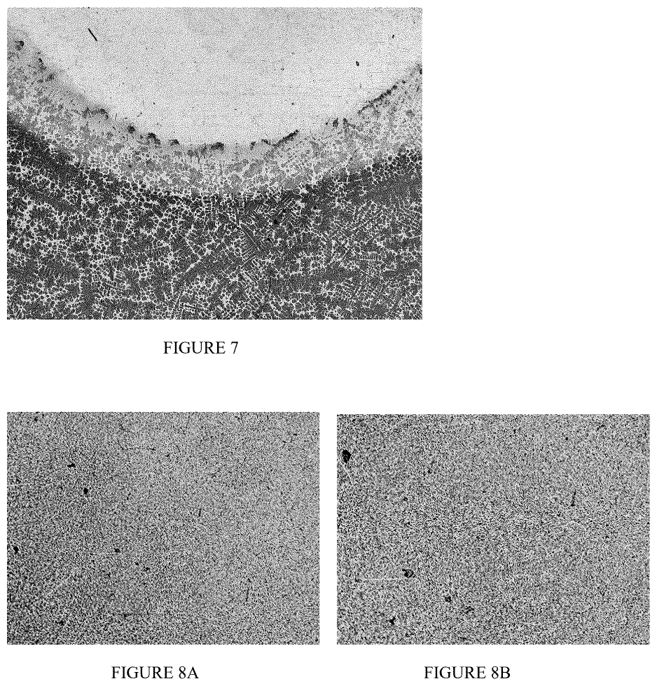

FIG. 7 shows an image of weldment of laser beam (1 kw) clad of Jonesite 19 on J130 which displays a sound bonding between Jonesite 19 and J130 along with a distinct heat-affected zone under an etched condition. The uniform distribution of heat-affected zone implies the existence of clearly different physical property such as heat capacity, between intermetallic material and carbon steel substrate.

The fusion zone microstructure for Jonesite 19 clad on a J130 substrate is shown in FIG. 8A at 100× and in FIG. 8B at 200×. The Jonesite 19 powder was fed at a rate of 42.5 g/minute and as shown in FIGS. 8A and 8B, the as-clad microstructure of the NiNb intermetallic cladding has a uniform distribution of nickel-niobium intermetallic phases.

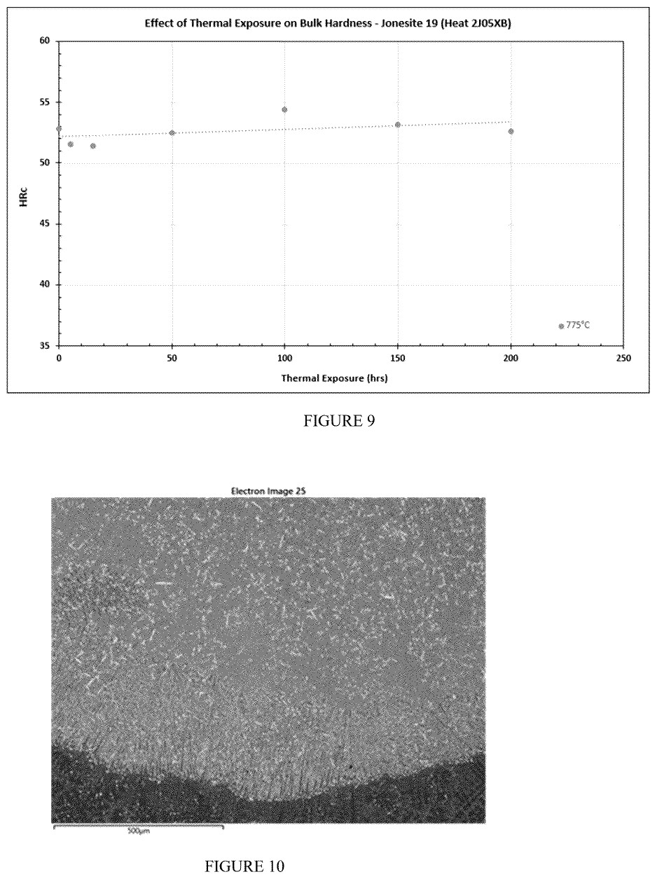

FIG. 9 is a graph of hardness versus time for a cladding of Jonesite 19 wherein it can be seen that the hardness remains essentially constant at between 50 and 55 HRc after heating at 775 °C for up to 250 hours. Due to the intermetallic matrix of the nickel-niobium intermetallic alloy cladding, no significant precipitation is observed in the cladding due to thermal aging.

FIG. 10 is a micrograph of a nickel-niobium intermetallic alloy cladding on a wear resistant tool steel (J130 tool steel) wherein it can be seen that a dendritic subzone of the cladding adjacent the metal substrate has a dendritic microstructure extending about 500 microns (0.5 mm) and the rest of the cladding exhibits a uniform mixture of nickel-niobium intermetallic phases. As shown in FIG. 1, laser cladding a Ni—Nb intermetallic alloy powder onto a wear resistant tool steel such as J130 tool steel can provide a cladding having a uniform intermetallic microstructure with a uniform level of hardness of 500-600 HV (Vickers hardness 500 g) extending at least 1 mm from the outer surface of the cladding.

In an embodiment, J130 tool steel (1.2-1.8% C, 0.7-1.5% V, 7-11% Cr, 6-11% Mo, 1-3.5% Nb, 0.005-0.5% B, balance Fe) is cladded with a Ni—Nb intermetallic alloy (up to 3.5% Si, 5-15% Cr, 45-75% Ni, 14-30% Nb, up to 7% Co, up to 10% Fe). An analysis of the microstructure of the fusion zone of Jonesite 19 clad on J130 tool steel reveals two subzones in the fusion zone (cladding). An upper portion of the cladding contains significantly dispersed niobium carbide/niobium nitride/niobium carbonitride (NbC/NbN/NbCN) phases (up to a total of 2.5 volume % of these phases) whereas a lower portion of the cladding contains cellular dendritic substructure which is connected to the cladding heat-affected zone where the substructure growth initiated.

In an embodiment, the metal substrate (onto which the Ni—Nb intermetallic cladding is applied) can be a tool steel comprising carbon (C) such as 1-2 wt. % C, chromium (Cr) such as 7-15 wt. % Cr, molybdenum (Mo) such as 4-12 wt. % Mo, optional tungsten (W) such as 0-5 wt. % W, optional cobalt (Co) such as 0-5 wt. % Co, optional niobium (Nb) such as 0-4 wt. % Nb, optional vanadium (V) such as 0-2 wt. % V, optional copper (Cu) such as 0-4 wt. % Cu, optional manganese (Mn) such as 0-2 wt. % Mn, optional silicon (Si) such as 0-2 wt. % Si, optional nickel (Ni) such as 0-3 wt. % Ni, optional boron (B) such as 0-0.5 wt. % B, balance iron (Fe) and 0-2 wt. % total impurities.

In an embodiment, the metal substrate can be a low alloy steel comprising 0.3 to 0.5 percent carbon, 0.5 to 1.5 percent chromium, 0.15 to 0.5 percent molybdenum, up to 0.5 percent tungsten, up to 0.5 percent cobalt, up to 0.5 percent niobium, up to 0.5 percent vanadium, up to 0.5 percent copper, 0.5 to 1.5 percent manganese, 0.15 to 0.5 percent silicon, up to 0.5 percent nickel, up to 0.1 percent boron, up to 1 percent unavoidable impurities, balance iron. For example, the low alloy steel can be AISI 4140 (0.38-0.43% C, 0.8-1.1% Cr, 0.15-0.25% Mo, 0.75-1% Mn, 0.15-0.3% Si, balance Fe and impurities) or AISI 4142 (0.4-0.45% C, 0.8-1.1% Cr, 0.15-0.25% Mo, 0.75-1.1% Mn, 0.15-0.3% Si, balance Fe and impurities). Low alloy steel substrates clad with Nb-Ni intermetallic alloy can be used for lower service temperature applications whereas tool steel (heat and wear resistant steels) substrates clad with Ni—Nb intermetallic alloy can be used for higher temperature applications and/or corrosive service environments. In addition, tool steel substrates can be used with Ni—Nb intermetallic alloy cladding applied in a single layer due to a lower dilution effect from high alloy substrate materials.

In an embodiment, a Ni—Nb intermetallic alloy cladding can be applied to a steel substrate by any suitable thermal spraying process such as laser cladding, arc spray, low pressure plasma, plasma transferred arc (PTA), or the like. For example, a pre-alloyed powder of the Ni—Nb intermetallic alloy can be fed to a nozzle of a laser cladding apparatus using a laser power of 600-10,000 watts (W), laser scanning speed of 2-50 millimeter per second (mm/s), powder feeding rate of 1-40 grams per minute (g/min) , single pass overlap of 25-60%, protective gas flow rate of 10-30 liters per minute (L/min) and/or spot diameter of 1.5-6 millimeter (mm). The cladding can be deposited on the substrate with a width of 0.1-5 mm and in a thickness of 0.1-5 mm in a single pass or via multiple passes up to 5 mm or over 5 mm in cladding thickness.

During laser cladding the Ni—Nb intermetallic alloy powder onto a metal substrate, the powder melts and is rapidly solidified upon contact with the metal substrate and/or previously deposited nickel-niobium intermetallic alloy cladding. Due to the high temperature of the melted Ni—Nb intermetallic powder, the surface of the metal substrate contacted by the melted Ni—Nb intermetallic powder melts and intermixes with the molten Ni—Nb intermetallic powder to form a fusion zone. Depending on the scanning speed of the laser cladding process, a cladding layer is built up such that a surface region of the cladding consists of resolidified Ni—Nb intermetallic alloy having at least 80 volume %, preferably at least 90 volume %, intermetallic phases such as Ni₃Nb and/or Ni₈Nb₇.

In an embodiment, the nickel-niobium intermetallic alloy cladding is deposited onto a metal substrate such as a steel substrate, a nickel-base substrate, a superalloy substrate such as a nickel base superalloy or cobalt base superalloy. For example, the Ni—Nb intermetallic alloy cladding can be deposited by laser cladding or plasma spraying. In the case of plasma spraying, the Ni—Nb intermetallic alloy cladding can be thermally sprayed by introducing a gas between an electrode and the metal substrate sufficient to create a plasma arc which heats a zone of the metal substrate, injecting the pre-alloyed Ni—Nb intermetallic powder into the plasma arc so that the powder is heated to its melting point and metallurgically bonds to the metal substrate in the zone, and moving the metal substrate past the electrode to form a first layer of Ni—Nb intermetallic alloy cladding on the metal substrate. The cladding can be a single pass cladding or multi-pass cladding in which a second layer of the Ni—Nb intermetallic alloy cladding is deposited over the first layer of cladding. Details of a suitable plasma spraying apparatus and method can be found in U.S. Pat. No. 4,878,953 and U.S. Published Patent Application 2011/0094629, the subject matter of each is hereby incorporated by reference. Alternatively, the cladding can be deposited by laser cladding, details of which can be found in U.S. Pat. Nos. 4,532,191 and 6,277,500 and U.S. Patent Publication No. 2014/0299585, the subject matter of each is hereby incorporated by reference.

The pre-alloyed Ni—Nb intermetallic powder can be prepared by any suitable technique such as mechanical mixing such as ball milling a pre-alloyed bar of the nickel-niobium intermetallic alloy, atomization such as gas atomizing or water atomizing, or other technique for producing pre-alloyed powder having a particle size suitable for thermal spraying. For example, the pre-alloyed powder can have a particle size of 20 to 150 microns. The Ni—Nb intermetallic powder can be cladded on a metal substrate with or without preheating the metal substrate. If the metal substrate is not pre-heated, the portion of the Ni—Nb intermetallic alloy cladding in contact with the metal substrate can have a dendritic microstructure due to a high temperature gradient. By preheating the metal substrate to temperatures such as 200-600 °F, the dendritic microstructure can be eliminated or reduced in thickness compared to a metal substrate which is not preheated. In either case, the Ni—Nb intermetallic alloy cladding exhibits at least 80 volume %, preferably at least 90 volume %, Ni—Nb intermetallic phases in the as-clad condition. These Ni—Nb intermetallic phases form during solidification of the cladding. Due to the composition of the Ni—Nb intermetallic alloy powder, there is no precipitation of additional Ni—Nb intermetallic compounds during heat treatment of the cladding. Thus, the cladding exhibits high wear resistance, oxidation resistance and/or corrosion resistance in the as-deposited (as-clad) condition.

The metal substrate can be any component to be exposed to sliding wear, corrosive atmospheres, For example, the metal substrate can be a structural part such as a furnace component, a part subject to wear and corrosion such as engine parts including valves, valve seats, a superalloy part such as a turbine disk, turbine seal, turbine blade, turbine shroud, turbine frame or casing, hydraulic flow passage components, valve head of a steam turbine valve rod, pump components such as pump housing or pump impeller, liners for grinding mills, ground engaging tools, mining components or other parts requiring wear and/or corrosion resistance.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An article comprising a metal substrate and a nickel-niobium intermetallic alloy cladding thereon, the nickel-niobium intermetallic alloy cladding bonded to the metal substrate by a fusion boundary, the nickel-niobium intermetallic alloy cladding made from pre-alloyed nickel-niobium intermetallic alloy powder having up to 0.1 weight percent (wt. %) carbon, and the nickel-niobium intermetallic alloy cladding having a microstructure comprising at least 80 volume % nickel-niobium intermetallic phases and up to 20 volume % solid solution phases.

2. The article of claim 1, wherein the nickel-niobium intermetallic alloy cladding consists of, in weight percent, up to 3.5 percent silicon; 5 to 15 percent chromium; 45 to 75 percent nickel; 14 to 30 percent niobium; up to 7 percent cobalt; up to 10 percent iron; up to 0.1 percent carbon, up to 0.2 percent manganese, up to 0.5 percent molybdenum, up to 0.3 percent tungsten, up to 0.3 percent vanadium, and up to 0.1 percent each of titanium, zirconium, hafnium, tantalum, beryllium, aluminum, boron, sulfur, phosphorus, copper, calcium, nitrogen, oxygen, selenium, lead, yttrium, rare earth metals, and bismuth.

3. The article of claim 1, wherein the metal substrate is a nickel-base alloy and/or the nickel-niobium intermetallic alloy cladding comprises at least 90 volume % nickel-niobium intermetallic alloy phases.

4. The article of claim 1, wherein the cladding has been deposited by laser cladding.

5. The article of claim 1, wherein the metal substrate comprises a wear resistant tool steel or a low alloy steel and/or the article is a valve seat insert.

6. The article of claim 5, wherein the metal substrate comprises a wear resistant tool steel comprising 1 to 2 percent carbon, 7 to 15 percent chromium, 4 to 12 percent molybdenum, up to 5 percent tungsten, up to 4 percent cobalt, up to 4 percent niobium, up to 3 percent vanadium, up to 4 percent copper, up to 2 percent manganese, up to 2 percent silicon, up to 1 percent nickel, up to 1 percent boron, 60 to 80 percent iron and balance up to 1 percent unavoidable impurities.

7. The article of claim 5, wherein the metal substrate comprises a low alloy steel comprising 0.3 to 0.5 percent carbon, 0.5 to 1.5 percent chromium, 0.15 to 0.5 percent molybdenum, up to 0.5 percent tungsten, up to 0.5 percent cobalt, up to 0.5 percent niobium, up to 0.5 percent vanadium, up to 0.5 percent copper, 0.5 to 1.5 percent manganese, 0.15 to 0.5 percent silicon, up to 0.5 percent nickel, up to 0.1 percent boron, up to 1 percent unavoidable impurities, balance iron.

8. The article of claim 1, wherein the nickel-niobium intermetallic alloy cladding has a uniform hardness of between 500 and 600 HV across an outer surface and in a depth direction of at least 1 mm from the outer surface and/or the cladding has a hardness of 50-55 HRc after being heated at 775 °C for 250 hours.

9. The article of claim 1, wherein the nickel-niobium intermetallic alloy cladding has an outer zone of uniform lamellar microstructure and an inner zone of dendritic nickel-niobium intermetallic alloy extending outwardly from an outer surface of the metal substrate.

10. An article comprising a metal substrate and a nickel-niobium intermetallic alloy cladding thereon, wherein:
the nickel-niobium intermetallic alloy cladding is bonded to the metal substrate by a fusion boundary;
the nickel-niobium intermetallic alloy cladding is made from pre-alloyed nickel-niobium intermetallic alloy powder;
the nickel-niobium intermetallic alloy cladding has a microstructure comprising at least 80 volume % nickel-niobium intermetallic phases and up to 20 volume % solid solution phases;
the nickel-niobium intermetallic alloy cladding consists of, in weight percent, up to 3.5 percent silicon; 5 to 15 percent chromium; 45 to 75 percent nickel; 14 to 30 percent niobium; up to 7 percent cobalt; up to 10 percent iron; up to 0.1 percent carbon, up to 0.2 percent manganese, up to 0.5 percent molybdenum, up to 0.3 percent tungsten, up to 0.3 percent vanadium, and balance up to 0.1 percent each of titanium, zirconium, hafnium, tantalum, beryllium, aluminum, boron, sulfur, phosphorus, copper, calcium, nitrogen, oxygen, selenium, lead, yttrium, rare earth metals, and bismuth; and
the metal substrate is a tool steel comprising 1 to 2 percent carbon, 7 to 15 percent chromium, 6 to 12 percent molybdenum, up to 5 percent tungsten, up to 5 percent cobalt, up to 4 percent niobium, up to 3 percent vanadium, up to 4 percent copper, up to 2 percent manganese, up to 2 percent silicon, up to 3 percent nickel, up to 0.5 percent boron, up to 1 percent unavoidable impurities, balance iron.

11. A method of manufacturing the article of claim 1, wherein the nickel-niobium intermetallic alloy cladding is formed by laser cladding, the method comprising flowing the pre-alloyed nickel-niobium intermetallic alloy powder to a nozzle of a laser cladding apparatus, moving the metal substrate, and depositing the nickel-niobium intermetallic alloy cladding on the metal substrate.

12. The method of claim 11, wherein the laser cladding is performed using a laser power of 500 to 10,000 watts, a powder feed rate of 1 to 40 grams per minute, a scanning speed of 100 to 1000 millimeters per minute, a laser spot diameter of 1.5 to 6 mm, an overlapping rate of 25 to 70%, a protective gas flow of 10 to 30 liters per minute, a powder size of 100 to 600 mesh, and/or a cladding thickness of 0.1 to 5 mm.

13. The method of claim 11, wherein the pre-alloyed powder is an atomized powder containing, in weight percent, up to 3.5 percent silicon; 5 to 15 percent chromium; 45 to 75 percent nickel; 14 to 30 percent niobium; up to 7 percent cobalt; up to 10 percent iron, up to 0.1 percent carbon, up to 0.2 percent manganese, up to 0.5 percent molybdenum, up to 0.3 percent tungsten, up to 0.3 percent vanadium, and up to 0.1 percent each of titanium, zirconium, hafnium, tantalum, beryllium, aluminum, boron, sulfur, phosphorus, copper, calcium, nitrogen, oxygen, selenium, lead, yttrium, rare earth metals, and bismuth.

14. The method of claim 11, wherein the nickel-niobium intermetallic alloy cladding has no more than 2.5 volume percent carbide/nitride phases including niobium carbides, niobium-molybdenum carbides, niobium nitrides and niobium carbonitrides.

15. The method of claim 11, wherein the nickel-niobium intermetallic alloy cladding includes rod-like intermetallic phases of nickel-niobium.

16. The method of claim 11, wherein the nickel-niobium intermetallic alloy cladding includes a lamellar microstructure.

17. The method of claim 11, wherein the nickel-niobium intermetallic alloy cladding has less than 10 volume percent nickel-iron and nickel-cobalt solid solution phases.

18. The method of claim 11, wherein the pre-alloyed powder is prepared by forming a melt of the pre-alloyed alloy and atomizing the melt to form the pre-alloyed powder.

19. The method of claim 11, wherein during the laser cladding an outer surface of the metal substrate is heated to melt the metal substrate into a weld pool, the pre-alloyed powder is melted and solidified into a microstructure of at least 90 volume percent intermetallic phases with a uniform microstructure as the nickel-niobium intermetallic alloy cladding is formed.

20. The method of claim 19, wherein the nickel-niobium intermetallic alloy cladding is deposited with a uniform microstructure of nickel-niobium intermetallic alloy phases metallurgically bonded to the metal substrate by a thin fusion boundary interface of mixed metal substrate and the thin fusion boundary interface having a thickness of no greater than 5 microns.
